(19) United States
(12) Patent Application Publication
(10) Pub. No.: US 2002/0170032 A1
(43) Pub. Date: Nov. 14, 2002

(54) Method, system and computer program for deriving and applying quality of service specifications in a component-based development environment

(75) Inventors: John Anthony Beaven, Chandlers Ford Eastleigh (GB); Thomas James Freund, Winchester (GB); Graham Castree Charters, Winchester (GB); Amanda Elizabeth Chessell, Alton (GB); Iain Stuart Caldwell Houston, Sherborne (GB); Peter Alexander Lambros, Southhampton (GB); Catherine Susan Griffin, Romsey (GB); Martin Mulholland, Winchester (GB); Francis Nicholas Parr, New York, NY (US); Ian Robinson, Southampton (GB); David John Vines, Romsey (GB); Christopher Frank Codella, Marlboro, NY (US)

Correspondence Address: Gregory M. Doudnikoff, IBM Corporation T81/503, PO Box 12195, Research Triangle Park, NC, 27709, US

(73) Assignee: International Business Machines Corporation, Armonk, NY (US)

(21) Appl. No.: 09/808,501

(22) Filed: Mar. 14, 2001

(51) Int. Cl. G06F 9/44

(52) U.S. Cl. 717/104

(57) ABSTRACT

Disclosed are a system, method and computer program for component-based processing, comprising a component specification element, a control flow specification element, a data flow specification element, a resource specification element, a quality of service specification derivation element having for output an application model in combination with a quality of service specification derived by implication from relations between components, control flows, data flows and resources, and a runtime engine for deploying said quality of service specification as a runtime contract in a runtime processing environment. Examples of such qualities of service are requirements of a process to have provided for it support for transactionality, recoverability, asynchronous messaging and the like.

### FIELD OF THE INVENTION

The present invention relates to the field of component-based development of computer applications and application systems, and more particularly to the development and interpretation of runtime specifications for such applications.

### BACKGROUND OF THE INVENTION

For some time, application programs and application program systems have been developed using object-oriented programming. A more recent development of such methods is the growing use of reusable components, assembled together into application programs in component-based development environments. Such components are, by their nature, designed to be somewhat generalized. That is, it is extremely difficult for such programs to be reusable in any practical sense and still be sufficiently tightly-specified to be operable in a real runtime computing environment.

The problems in such systems will become clear in the context of one such system, described here as an example of such component-based development environments.

In a component-based data processing environment, a system model can be defined as a set of nested communicating processing activities. Each activity (which may be an Enterprise Java Bean) performs a specified action based on the data or control event it receives from a client or from another activity.

Both data and control inputs and outputs are strictly defined for each activity. Such activities can be nested. That is, a first activity can initiate a second activity which performs processing on behalf of the first activity.

An example of such an environment is an Enterprise Java Beans environment, in which Java Bean components are used to perform data processing actions. When used as a data processing environment, the Enterprise Java Beans represent processing activities which may be linked (or “wired”) together in sequence, or executed in parallel, to perform processing on behalf of client programs. Such an environment is described in Enterprise Java Beans Technology, by Anne Thomas (published by Patricia Seybold Group), which is herein incorporated by reference. In such an environment, the degree of abstraction of the process of combining flexible components into a real-world runtime data processing system renders the problem of the detailed control of individual data processing elements, and all their relationships with heterogeneous resources in database and transaction processing systems for example, extremely difficult and typically time-consuming.

Object models, such as are typically used in defining component-based data processing systems, have the advantages of allowing abstraction and encapsulation of processing behavior. However, typically, an object in such an environment needs to “know” what services it invokes. This limits the flexibility and reusability of objects, which runs counter to one of the aims of a component-based systems approach, in which flexible reuse of components or varied purposes and at varied levels within the system hierarchy is a principal aim.

In a real-life business programming context, what is needed is a way to hide from the business programmer, who simply wishes to create a business application, the low-level system programming details, such as controlling the means by which components are connected to resources and the interactions between the components and the resource managers. Such a programmer, for maximum productivity, is most usefully employed in creating the programs that fulfill the requirements of the business process, and thus needs an environment in which a business activity can be insulated from knowledge of its environment. Such a separation of concerns has been a desirable attribute of systems for some time, as the data processing world seeks simpler ways of producing error-free programs that are sufficiently robust to be trusted to carry out vital business operations, that can be adapted to varying environments without extensive modification, and that can be rapidly deployed in complex distributed environments.

The environmental requirements of a process activity can be defined in terms of qualities of service (or QOS). A process activity typically requires certain services from the system environment in which it operates, in order for it to be deployed in that environment and to operate therein. One example of a quality of service for a process activity embodying a portion of business logic is the type of message environment in which it can operate. It may, for example, always require that its communications with other components are defined as synchronous links, or it may require that all components that communicate with it are capable of asynchronous processing using a messaging-and-queuing paradigm. Such requirements form the glue by which process activities can be usefully deployed in enterprise scale systems typically involving complex systems of heterogeneous subsystems.

At present, quality of service specifications are typically encoded within applications or application components, or within the communication flow elements of the system. Also typically, when a business process model is developed to model the business application or system, there is no direct connection between the attributes of the model's components and the real-life deployment of those attributes. Thus, a model is created and passes to the application developer, who needs to understand that certain parts of the process must have certain attributes, and who then encodes the instructions to embody those attributes directly into the program. An example is a programmer who receives as input a processing model in which a transaction updates data in a database. The programmer understands that such a transaction must have a fail-safe way of ensuring that the data is updated correctly, that the update happens once only, and that the previous database state must be returned to if anything goes wrong during the transaction. To achieve this, the programmer encodes a START TRANSACTION command that will be understood by a middleware transaction and resource management component, and then encodes appropriate COMMIT TRANSACTION and ROLLBACK commands to ensure that the successful and failing cases are correctly dealt with. The programmer thus needs to have an appropriate vocabulary of low-level commands that are not directly involved in the construction of a program to embody the business logic, but which are required in order to deploy the resulting program into its system environment, where it must interact with correct transactional characteristics with other components.

### SUMMARY OF THE INVENTION

The present invention accordingly provides, in a first aspect, a system for component-based processing, said system comprising: a component specification element; a control flow specification element; a data flow specification element; a resource specification element; and a quality of service specification derivation element having for output an application model in combination with a quality of service specification derived by implication from relations between components, control flows, data flows and resources; wherein said quality of service specification is made available to a runtime engine for deployment as a runtime contract in a runtime processing environment.

A computer system according to the first aspect preferably further comprises a runtime engine for deploying said runtime contract.

Preferably, said runtime contract comprises a messaging requirement contract.

Preferably, said runtime contract comprises a transactionality requirement contract.

Preferably, said runtime contract comprises a security requirement contract.

Preferably, said runtime contract comprises a recoverability requirement contract.

Preferably, said runtime contract comprises a completion requirement contract.

Preferably, said runtime contract comprises a completion requirement contract specifying transactional behavior.

Preferably, said runtime contract comprises a completion requirement contract specifying compensation behavior.

Preferably, said runtime contract comprises a t least one of a reliability, availability and serviceability requirement contract.

Preferably, said runtime contract comprises a quality of delivery requirement contract.

Preferably, said runtime contract comprises at least one of a priority requirement and a response goal requirement contract.

Preferably, said runtime contract comprises a performance requirement contract.

Preferably, said quality of service specification is stored in a repository.

Preferably, said quality of service specification is stored in a tagged markup language.

Preferably, said tagged markup language is XML.

Preferably, said quality of service specification is stored in a modeling language.

In a second aspect, the present invention provides a method for component-based processing, said method comprising the steps of: specifying a component; specifying a control flow; specifying a data flow; specifying a resource; deriving a quality of service specification by implication from relations between components, control flows, data flows and resources; and deploying, by a runtime engine, said quality of service specification as a runtime contract in a runtime processing environment.

Preferred features of the first aspect have corresponding preferred features in the second aspect.

In a third aspect, a computer program product is provided to perform the steps of a method according to the second aspect.

Preferred features of the second aspect have corresponding preferred features in the third aspect.

The present invention advantageously improves upon the existing systems of modeling business processes from components using a visual composition editor (VCE) by permitting a model to specify a process or application in such a way that its runtime requirements can be derived in the form of a contract for service which can be enacted in the deployment environment.

It further advantageously exploits the fact that, when a modeler has described the flow of data and control between process components and the resources used by those process components, a structure is thereby created that can be conveniently exploited as the structure on which to add properties that a runtime engine can treat as specifications of the qualities of service (QOS) that the composed process requires.

Being based upon a popular application development paradigm, that of visual composition from components, this invention achieves an advantage over the conventional ways of having an application deploy the underlying (object) services such as messaging, security and transactions. By collecting a complex specification—partly from what is made explicit in the model and partly by inference from the relations incorporated in the model—a runtime engine can be supplied with means to interpret the model in terms of the QOS properties added to each component in the composition and derive a “services contract” (e.g. a transactional contract, a messaging contract, a security contract, and so on) which can be enacted on behalf of the application.

### BRIEF DESCRIPTION OF THE DRAWINGS

A preferred embodiment of the present invention will now be described, by way of example only, with reference to the accompanying drawings, in which:

FIG. 1 shows in schematic form a set of interrelated components in a prior art component-based environment.

FIG. 2 shows a component-based environment according to a preferred embodiment of the present invention.

FIG. 3 shows a method for developing applications and deriving their QOS requirements in a preferred embodiment of the present invention.

FIG. 4 shows an exemplary set of elements within which a preferred embodiment of the present invention can use a runtime engine to deploy a runtime contract.

### DETAILED DESCRIPTION OF A PREFERRED EMBODIMENT OF THE INVENTION

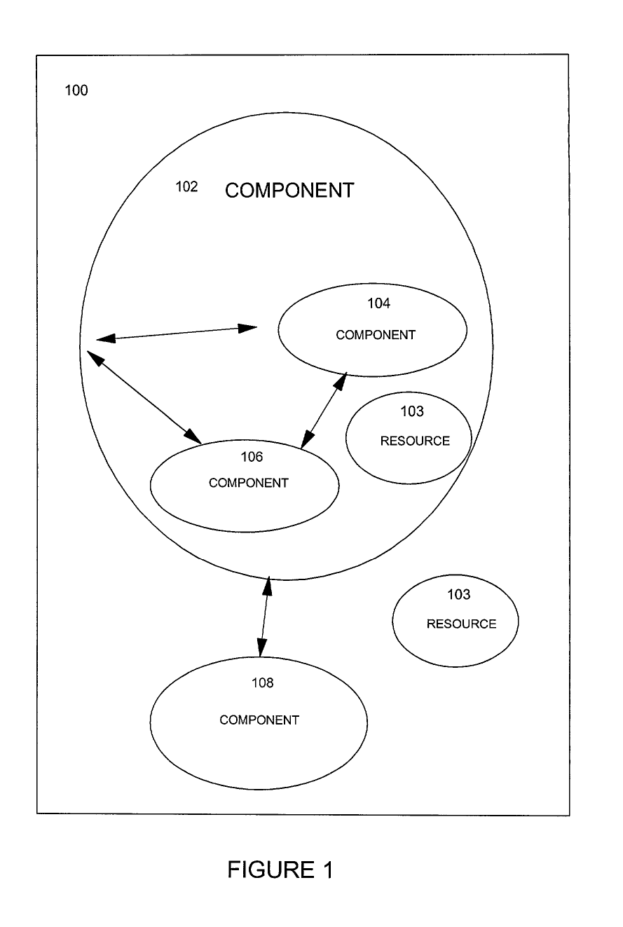

FIG. 1 shows a component-based environment having components (102,108), wherein component (102) further contains components (104, 106). The arrows in FIG. 1 indicate relationships between components representing control and data flows between the components. Components (104, 106) are shown as having such relationships with their containing component (102), with resources (103) and with one another.

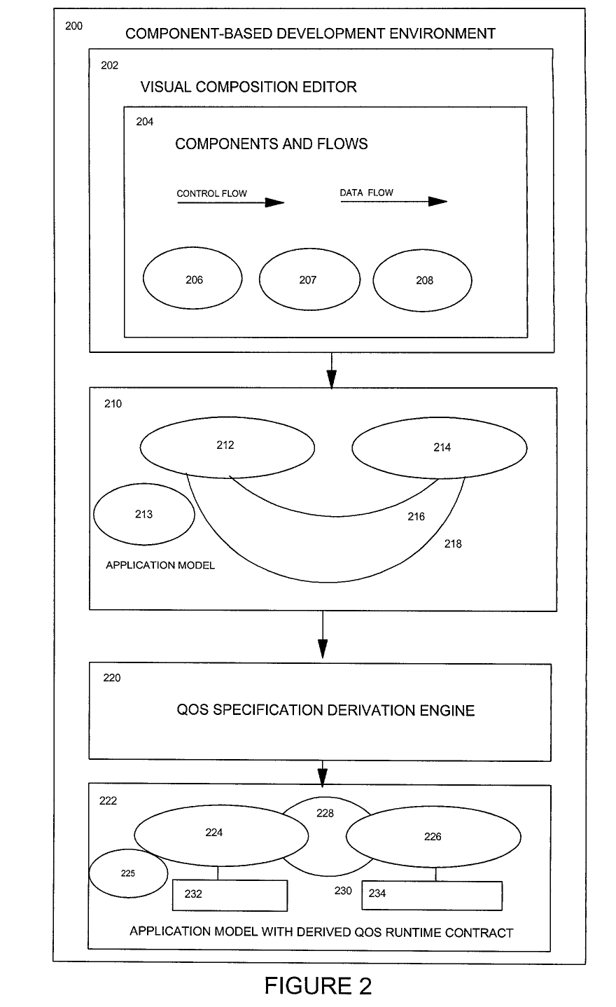

FIG. 2 shows a component-based development environment (200) of a preferred embodiment of the present invention. Within the component-based development environment is a visual composition editor (202) which allows components and flows (204) to be structured into applications. Exemplary components (206, 208) and resources (207) can be selected for reuse in various ways, and wired together in various ways, using the control flows and data flows provided in the repertoire of the visual composition editor (204). The visual composition editor (202) can be used in this way to construct application model (210), which comprises reusable components (212, 214) resources (213) and flows (216, 218), which may be control flows or data flows selected from the repertoire. Application model (210) can further be passed to a Quality of Service (QOS) specification derivation engine (220), which tests the components and the relationships between the components in the composed application model, and derives QOS specifications to be supplied in the form of a runtime contract. The output from the QOS specification derivation engine (220) is an application model with a derived QOS runtime contract (222), in which component (224) corresponding to component (212) and component (226), corresponding to component (214), are linked by flows (228, 230), corresponding respectively to flows (216, 218), resource (213) corresponding to resource (225), and contract elements (232, 234) representing the derived requirements for the runtime Quality of Service contract of the application. In one embodiment, the contract elements may be extracted from the model into the form of a metadata tree structure reflecting the relationships of the components, resources and flows. One example of such a tree is an XML representation of the metadata. Alternatively, the metadata may be held in the form of a further model, such as a Universal Modeling Language (UML) model.

The QOS contract may be, for example, a requirement that the application be run with the transactional properties provided for by the runtime environment. Alternatively or in addition, the application may have requirements such as recoverability, compensability by compensation actions in the wider system environment, security, or messaging (that is, the requirement that it communicate using a messaging-and-queuing paradigm).

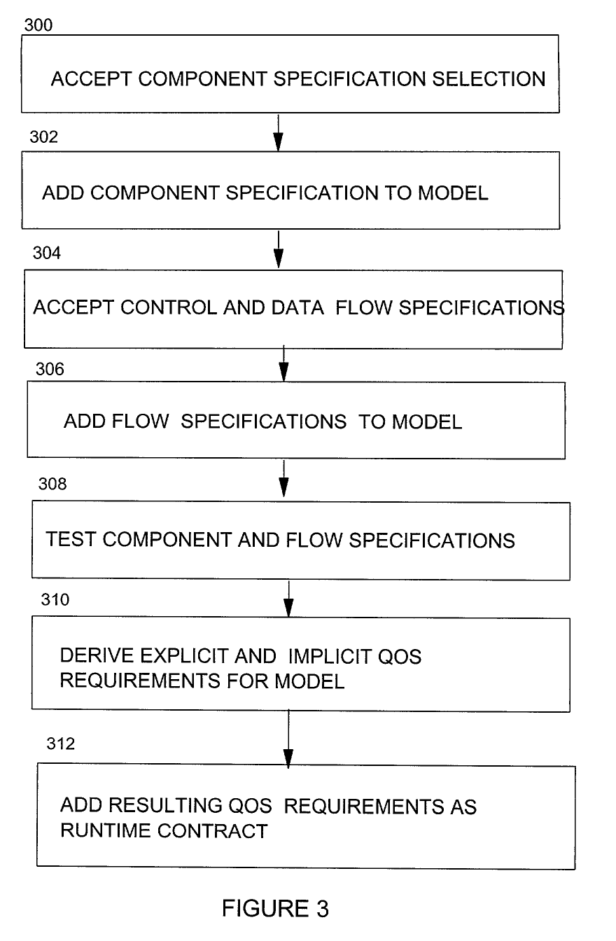

FIG. 3 shows the steps of a method according to a preferred embodiment of the present invention. At step (300), the component-based development environment accepts a component specification selection, which it adds at step (302) to the model. At step (304), the component-based development environment accepts control and data flow specifications. At step (306) the flow specifications are added to the model. In the preferred embodiment, both components and flows are represented using a visual programming metaphor. Clearly, however, any definitional mechanism that achieves the same object may be used. At step (308) the QOS specification derivation engine is used to test the component and flow specifications in the composed application. At step (310), the QOS specification derivation engine derives the explicit and implicit QOS requirements for the model, based on any such requirement explicitly attached to components or flows by the developer and on requirements that are susceptible to being derived automatically from the relationships within the specifications for the composed model. For example, if two components are predefined as requiring communication using a messaging-and-queuing paradigm, that requirement can be derived by rule for any interposed connecting wire or flow.

At step (312), the QOS specification derivation engine adds the derived QOS requirements to the model and derives a contract defining the deployment requirements of the modelled components.

In the preferred embodiment, the runtime engine hides from the person (or people) who developed the application model the exact details of how the derived contract is honoured (deployed). The graphical representation of the application model, together with its associated qualities of service can be represented in XML as a hierarchical structure with QOS properties attached to different elements at each level, and these QOS properties can then be enacted in the target processing environment.

In one embodiment, the business process model can be developed to produce a structured process comprising reusable platform-independent code components in the form of Enterprise Java Beans (EJB). At the same time, those QOS properties that are not suitable to be enacted within the EJB (because they are not part of the reusable business logic embodied in the EJB) can be derived from the model, stored in the form of properties on an XML tree representing the model, and subsequently used to create a run-time contract specifying the services that are required to be provided by the target environment. The runtime engine can then ensure that the contract is honoured by creating container objects that can support the interfaces that are required by the EJB to meet its quality of service requirements. However, there are many alternative embodiments that would be clear to one skilled in the art, such as the use of component-based objects of a type other than EJBs, or the use of means of storing the QOS properties other than as properties attached to an XML tree, for example in the form of modeling language constructs, or the provision of service interfaces other than by container objects, for example, by supplying a unitary, common service layer comprising all possible service interfaces for use by all components.

The model is then interpreted by a runtime engine which is designed to honour (deploy) the runtime contract by invoking the functionality of system services such as messaging middleware, a transaction service, logging, recovery, security and others as required by the contract.

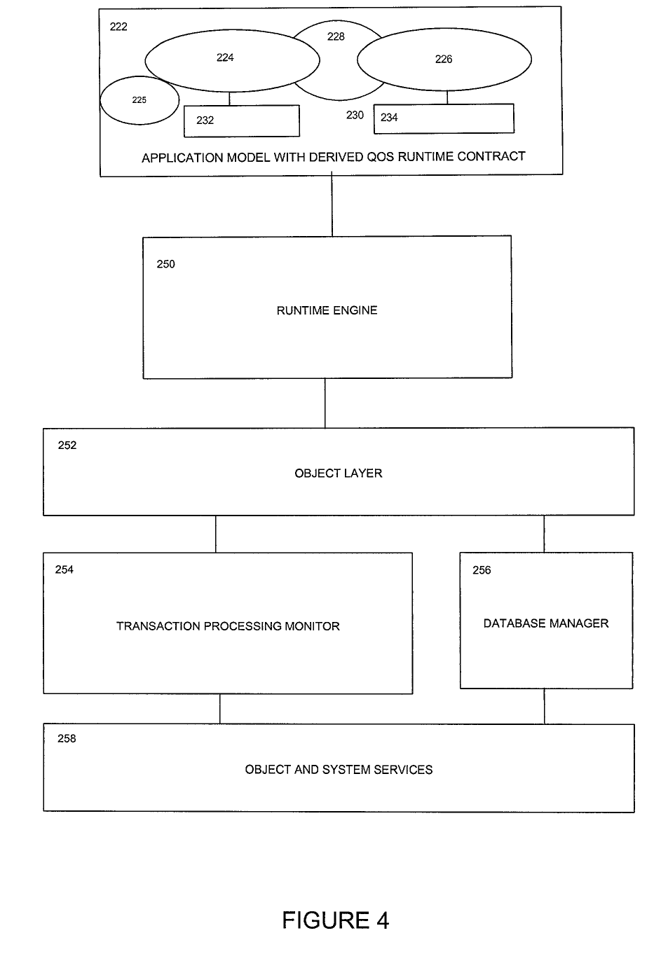

In FIG. 4, runtime engine (250) takes as input the contract (222) encoded in XML and uses a transaction processing monitor (254) such as IBM's CICS™ transaction processing product and a database manager (256) such as IBM's DB2 database system to deploy the contract. It can do this by using an object layer (252) like an EJB Server or a CORBA-compliant system like IBM's WebSphere™ product, Iona's Orbix™ or BEA's WebLogic™ for convenience or, for reasons of efficiency, some combination of an object layer (252); transaction processing monitor (254); database manager (256); and system services (258) to achieve the messaging, security, transactional, compensation and other QOS (qualities of service) specifications represented in the contract (222).

The present invention is preferably embodied as a computer program product for use with a computer system. Such an implementation may comprise a series of computer readable instructions either fixed on a tangible medium, such as a computer readable medium, e.g., diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

What is claimed is:

1. A system for component-based processing, said system comprising:
a component specification element;
a control flow specification element;
a data flow specification element;
a resource specification element; and
a quality of service specification derivation element having for output an application model in combination with a quality of service specification derived by implication from relations between components, control flows, data flows and resources;
wherein said quality of service specification is made available to a runtime engine for deployment as a runtime contract in a runtime processing environment.

2. A computer system as claimed in claim 1, further comprising a runtime engine for deploying said runtime contract.

3. A computer system as claimed in claim 1, wherein said runtime contract comprises a messaging requirement contract.

4. A computer system as claimed in claim 1, wherein said runtime contract comprises a transactionality requirement contract.

5. A computer system as claimed in claim 1, wherein said runtime contract comprises a security requirement contract.

6. A computer system as claimed in claim 1, wherein said runtime contract comprises a recoverability requirement contract.

7. A computer system as claimed in claim 1, wherein said runtime contract comprises a completion requirement contract.

8. A computer system as claimed in claim 7, wherein said runtime contract comprises a completion requirement contract specifying transactional behavior.

9. A computer system as claimed in claim 7, wherein said runtime contract comprises a completion requirement contract specifying compensation behavior.

10. A computer system as claimed in claim 1, wherein said runtime contract comprises at least one of a reliability, availability and serviceability requirement contract.

11. A computer system as claimed in claim 1, wherein said runtime contract comprises a quality of delivery requirement contract.

12. A computer system as claimed in claim 1, wherein said runtime contract comprises at least one of a priority requirement and a response goal requirement contract.

13. A computer system as claimed in claim 1, wherein said runtime contract comprises a performance requirement contract.

14. A computer system as claimed in claim 1, wherein said quality of service specification is stored in a repository.

15. A computer system as claimed in claim 1, wherein said quality of service specification is stored in a tagged markup language.

16. A computer system as claimed in claim 15, wherein said tagged markup language is XML.

17. A computer system as claimed in claim 1, wherein said quality of service specification is stored in a modeling language.

18. A method for component-based processing, said method comprising the steps of:
specifying a component;
specifying a control flow;
specifying a data flow;
specifying a resource; and
deriving a quality of service specification by implication from relations between components, control flows, data flows and resources;
wherein said quality of service specification is made available to a runtime engine for deployment as a runtime contract in a runtime processing environment.

19. A method as claimed in claim 18, further comprising the step of deploying said runtime contract by a runtime engine.

20. A method as claimed in claim 18, wherein said runtime contract comprises a transactionality requirement contract.

21. A method as claimed in claim 18, wherein said runtime contract comprises a security requirement contract.

22. A method as claimed in claim 18, wherein said runtime contract comprises a recoverability requirement contract.

23. A method as claimed in claim 18, wherein said runtime contract comprises a completion requirement contract.

24. A method as claimed in claim 23, wherein said runtime contract comprises a completion requirement contract specifying transactional behavior.

25. A method as claimed in claim 23, wherein said runtime contract comprises a completion requirement contract specifying compensation behavior.

26. A method as claimed in claim 18, wherein said runtime contract comprises at least one of a reliability, availability and serviceability requirement contract.

27. A method as claimed in claim 18, wherein said runtime contract comprises a quality of delivery requirement contract.

28. A method as claimed in claim 18, wherein said runtime contract comprises at least one of a priority requirement and a response goal requirement contract.

29. A method as claimed in claim 18, wherein said runtime contract comprises a performance requirement contract.

30. A method as claimed in claim 18, wherein said quality of service specification is stored in a repository.

31. A method as claimed in claim 18, wherein said quality of service specification is stored in a tagged markup language.

32. A method as claimed in claim 31, wherein said tagged markup language is XML.

33. A method as claimed in claim 18, wherein said quality of service specification is stored in a modeling language.

34. A computer program comprising computer program code to, when loaded and executed on a computer, cause said computer to perform the steps of a method as claimed in claim 18.

35. A computer program comprising computer program code to, when loaded and executed on a computer, cause said computer to perform the steps of a method as claimed in claim 19.

36. A computer program comprising computer program code to, when loaded and executed on a computer, cause said computer to perform the steps of a method as claimed in claim 20.

37. A computer program comprising computer program code to, when loaded and executed on a computer, cause said computer to perform the steps of a method as claimed in claim 21.

38. A computer program comprising computer program code to, when loaded and executed on a computer, cause said computer to perform the steps of a method as claimed in claim 22.

39. A computer program comprising computer program code to, when loaded and executed on a computer, cause said computer to perform the steps of a method as claimed in claim 23.

40. A computer program comprising computer program code to, when loaded and executed on a computer, cause said computer to perform the steps of a method as claimed in claim 24.

41. A computer program comprising computer program code to, when loaded and executed on a computer, cause said computer to perform the steps of a method as claimed in claim 25.

42. A computer program comprising computer program code to, when loaded and executed on a computer, cause said computer to perform the steps of a method as claimed in claim 26.

43. A computer program comprising computer program code to, when loaded and executed on a computer, cause said computer to perform the steps of a method as claimed in claim 27.

44. A computer program comprising computer program code to, when loaded and executed on a computer, cause said computer to perform the steps of a method as claimed in claim 28.

45. A computer program comprising computer program code to, when loaded and executed on a computer, cause said computer to perform the steps of a method as claimed in claim 29.

46. A computer program comprising computer program code to, when loaded and executed on a computer, cause said computer to perform the steps of a method as claimed in claim 30.

47. A computer program comprising computer program code to, when loaded and executed on a computer, cause said computer to perform the steps of a method as claimed in claim 31.

48. A computer program comprising computer program code to, when loaded and executed on a computer, cause said computer to perform the steps of a method as claimed in claim 32.

49. A computer program comprising computer program code to, when loaded and executed on a computer, cause said computer to perform the steps of a method as claimed in claim 33.
